(19) United States
(12) Patent Application Publication
(10) Pub. No.: US 2014/0071158 A1
(43) Pub. Date: Mar. 13, 2014

(54) Interface Integrating Key Peformance Indicator (KPI) to Custom Control

(71) Applicants: Dagmar Opitz, Walldorf (DE); Arnulf Schueler, Walldorf (DE); Sven-Eric Eigemann, Walldorf (DE); Daniel Jakobs, Walldorf (DE); Thomas Maag, Walldorf (DE); Lan Zhang, Walldorf (DE)

(72) Inventors: Dagmar Opitz, Walldorf (DE); Arnulf Schueler, Walldorf (DE); Sven-Eric Eigemann, Walldorf (DE); Daniel Jakobs, Walldorf (DE); Thomas Maag, Walldorf (DE); Lan Zhang, Walldorf (DE)

(73) Assignee: SAP AG, Walldorf (DE)

(21) Appl. No.: 13/608,802

(22) Filed: Sep. 10, 2012

(51) Int. Cl. G09G 5/00

(52) U.S. Cl. 345/619

(57) ABSTRACT

A user interface integrates display of custom Key Performance Indicators (KPIs) calculated from an underlying database. The interface may allow for the creation of predictive algorithms customized to provide intelligent advice and meaningful alerts to the user in realtime, based upon the value of the KPIs. Certain embodiments may provide a dynamic ticker feature that provides recommendations for user action based upon displayed KPIs. The ticker may utilize attributes such as color and movement to effectively communicate relevant KPI information to the user.

### BACKGROUND

Embodiments of the present invention relate to storage of information in databases, and in particular, to a database interface that integrates custom control over key performance indicator (KPI) data.

Unless otherwise indicated herein, the approaches described in this section are not prior art to the claims in this application and are not admitted to be prior art by inclusion in this section.

A database is a useful way of storing data volumes of related data. Often, analysis of the stored data may be in the form of one or more Key Performance Indicators (KPIs).

Conventionally, interfaces to databases afforded access to KPI data only upon entry of relevant information by the user, followed by the database engine producing the relevant result for display. However, such approaches require ongoing attention and manual interaction with the interface, reducing efficiency of the user to perform other tasks.

Accordingly, the present disclosure addresses these and other issues with user interfaces integrating KPI information and providing custom control over same.

### SUMMARY

A user interface allows creation of custom Key Performance Indicators (KPIs) calculated from an underlying database, as well as display of those KPIs to a user. The interface may allow for the creation of predictive algorithms customized to provide intelligent advice and meaningful alerts to the user in realtime, based upon the value of the KPIs. Interfaces according to certain embodiments may include a dynamic ticker display feature providing recommendations for user action based upon the KPIs. The ticker may utilize attributes such as color, logos, movement (e.g. scrolling), and/or sound to effectively communicate relevant KPI information to the user.

An embodiment of a computer-implemented method comprises causing an interface engine to automatically receive a key performance indicator (KPI) from a database, and causing the interface engine to display the KPI on a ticker of a screen.

An embodiment of a non-transitory computer readable storage medium embodies a computer program for performing a method comprising causing an interface engine to automatically receive a key performance indicator (KPI) from a database, and causing the interface engine to display the KPI on a ticker of a screen.

An embodiment of a computer system comprises one or more processors and a software program executable on said computer system. The software program is configured to cause an interface engine to automatically receive a key performance indicator (KPI) from a database, and configured to cause the interface engine to display the KPI on a ticker of a screen.

Certain embodiments further comprise causing the interface engine to display a recommended action based upon the KPI.

Some embodiments further comprise causing the interface engine to receive an input from a user to define the KPI, and causing the interface engine to communicate with the database engine to calculate the KPI from the database.

According to particular embodiments the KPI is displayed with a color to indicate a status.

In various embodiments the KPI is displayed with movement.

According to particular embodiments the database is configured to store Enterprise Resource Planning (ERP) data.

The following detailed description and accompanying drawings provide a better understanding of the nature and advantages of particular embodiments.

### BRIEF DESCRIPTION OF THE DRAWINGS

FIG. 1 is a schematic diagram providing a simplified view of a method according to an embodiment.

FIG. 1A is a simplified flow diagram showing a method according to an embodiment.

FIG. 2A shows a simplified view of a home screen display referencing KPI information according to one example.

FIG. 2B shows a simplified view of a KPI detail screen reached through the home screen of FIG. 2A.

FIGS. 2C1-5 are examples of screenshots of an interface which may be used for KPI customization.

FIG. 3 illustrates hardware of a special purpose computing machine configured to provide an interface according to an embodiment.

FIG. 4 illustrates an example of a computer system.

### DETAILED DESCRIPTION

Described herein are techniques for providing a user interface integrating KPI information. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

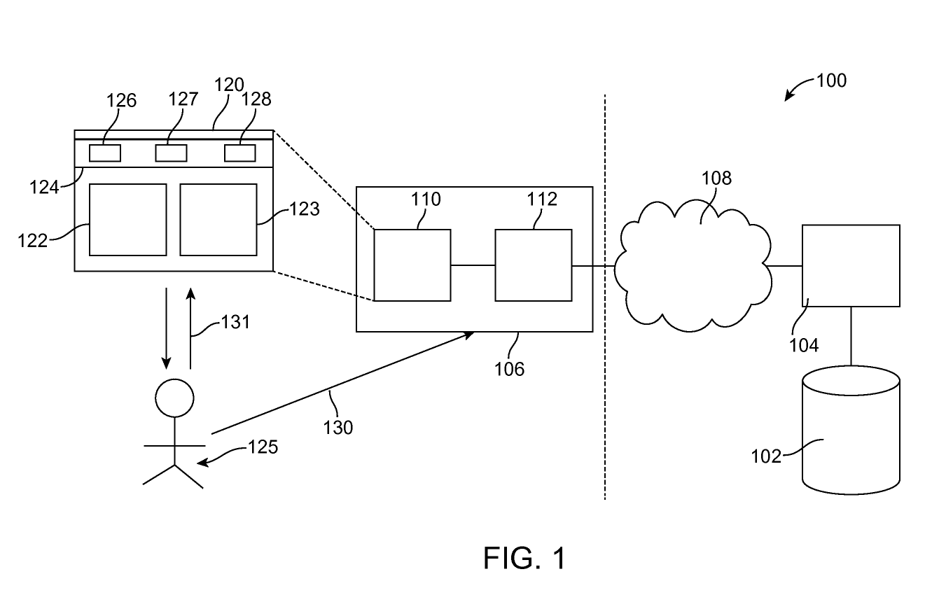

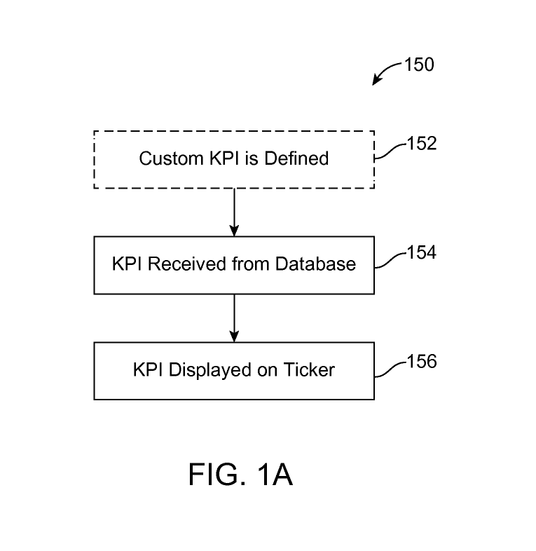

FIG. 1 shows a simplified view of an interface according to an embodiment. System 100 comprises a database 102 having information stored thereon, that is in communication with a database engine 104. In one particular example, the database could be configured to store a plurality of information relating to a specific business enterprise, for example sales data, customer data, and vendor data.

As shown in FIG. 1, the database engine 104 is in communication with a user device 106 via a communications network 108. In FIG. 1, the communications network is shown as a cloud for the sake of simplicity. It could be a wireless communications network, a wired communications network, or even some combination thereof.

The user device 106 comprises a screen 110 and an interface engine 112 in communication therewith. The interface engine is configured to automatically receive information from the database via the communications network and the database engine, and to display that information on the screen.

In particular, the user interface 120 displayed on the screen includes a plurality of regions 122-124, including a ticker region 124. The ticker region 124 is configured to display to a user 125, information regarding one or more KPI items 126-128 stored within the database. The KPI items may be displayed to the user in conjunction with aspects such as color, logos, and/or movement.

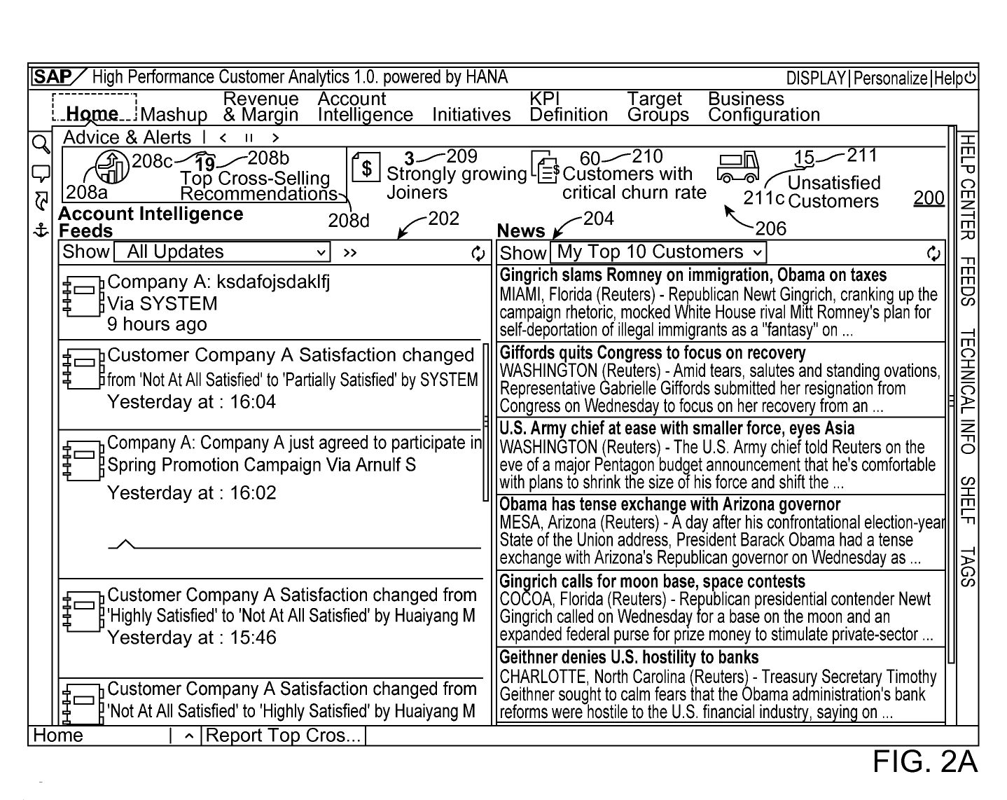

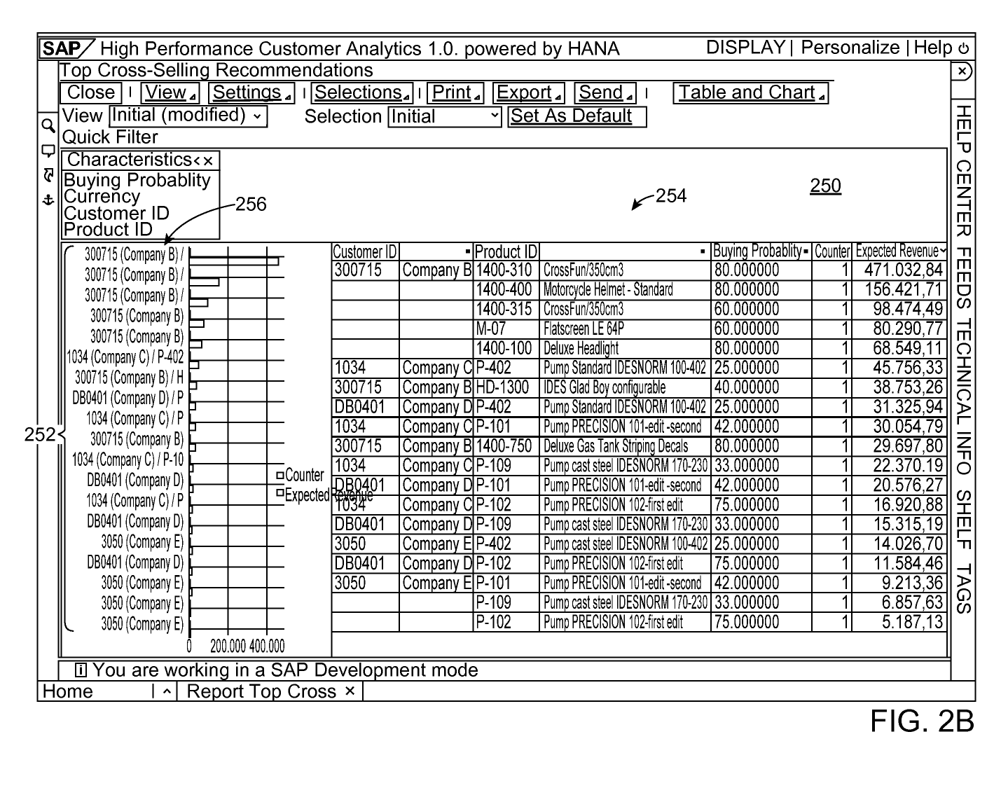

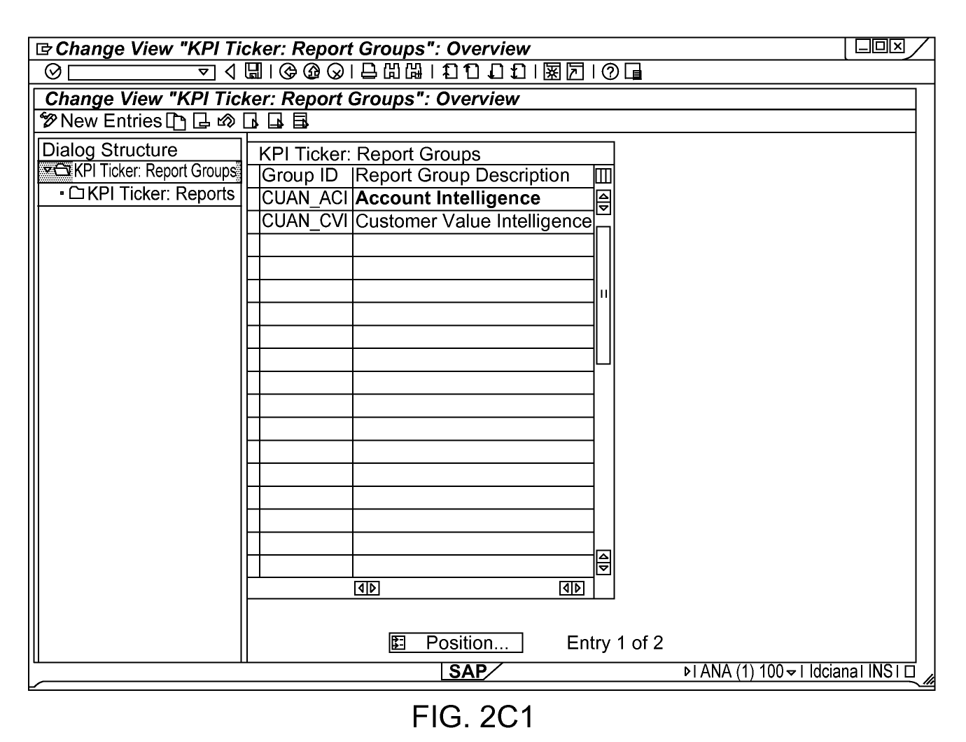

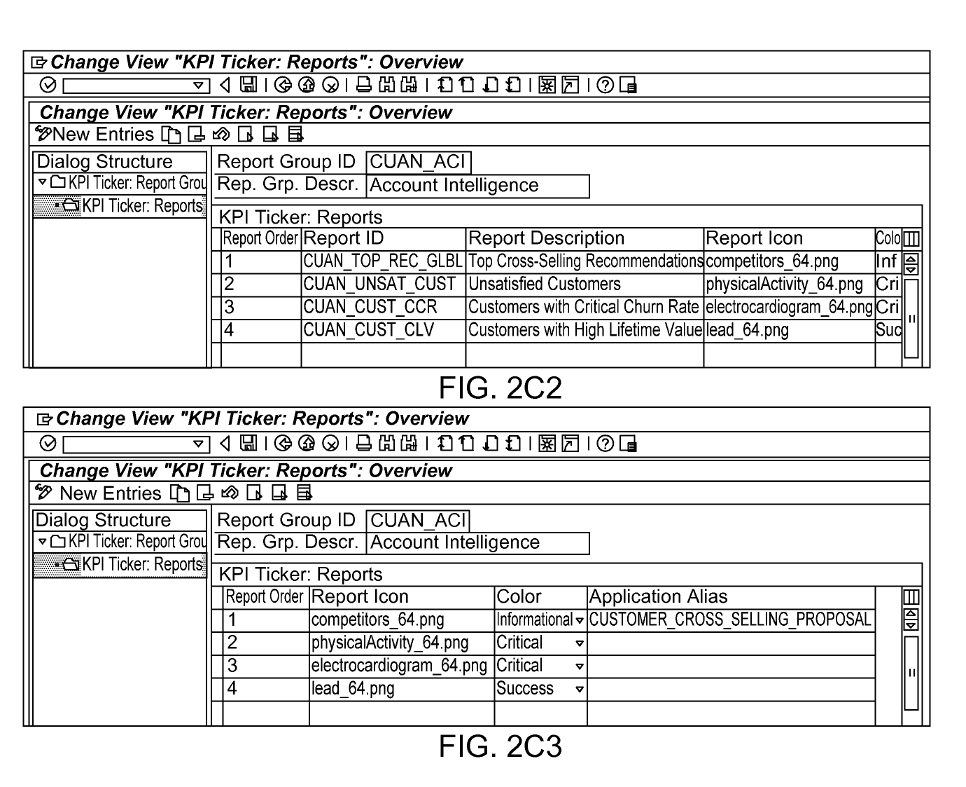

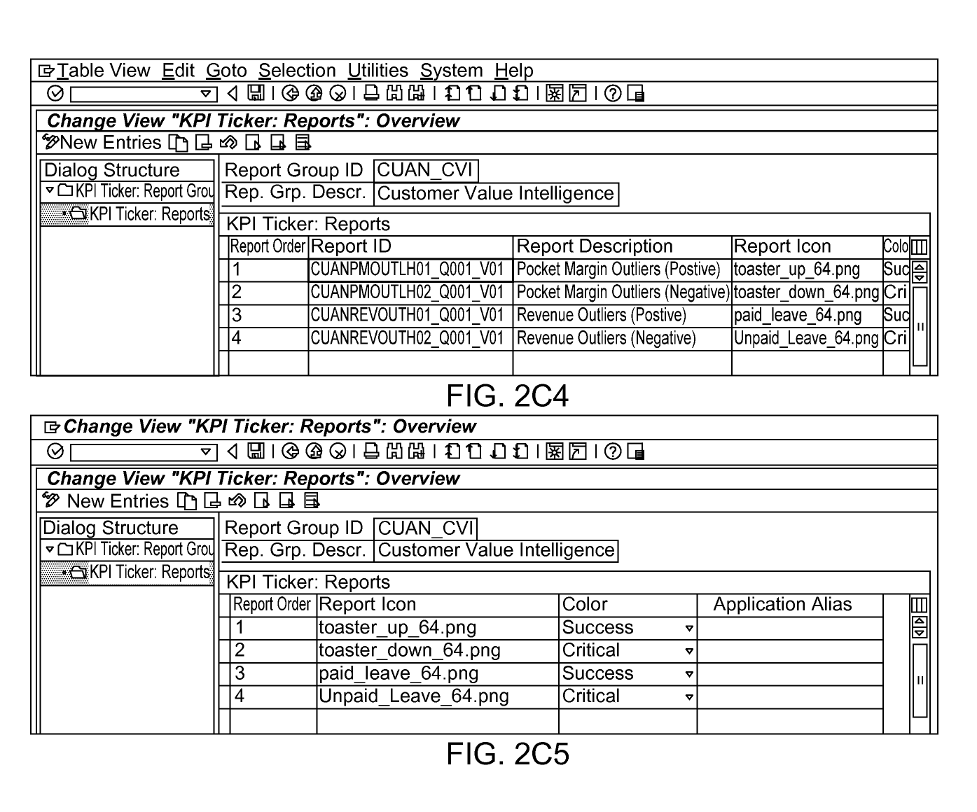

A customizing feature may allow definition of features including but not limited to KPIs that are to be displayed, grouping of KPIs, icons assigned KPIs, and KPI type (e.g. informational, critical, or success). KPIs may be calculated upon accessing the user interface, in some embodiments in real time or near real time. FIGS. 2C1-5 show example screenshots of an interface which may be used for KPI customization.

The interface engine is also configured to receive input 130 from the user via an input device (e.g. a keyboard and/or by touch 131 the screen if the screen is a touchscreen), and to communicate that input to the database via the communications network and the database engine. For example, in a particular embodiment, the interface may feature one or more drill-down screens accessed from items of the ticker portion.

Such drill-down screens may provide detailed information regarding particular KPIs, including recommendations for possible action based on the KPIs. The drill-down screens may allow further investigation by the user of alerts related to KPIs.

According to certain embodiments, the interface may feature one or more screens that are dedicated to allowing the user to create customized KPIs within the database. In an Enterprise Resource Planning (ERP) environment, for example, types of KPIs that may be created and then displayed include but are not limited to aggregated business metrics such as Cross-Selling Recommendations, Unsatisfied Customers, Customers with Critical Churn Rate, Customers with High Lifetime Value, Pocket Margin Outliers (Positive), Pocket Margin Outliers (Negative), Revenue Outliers (Positive), and Revenue Outliers (Negative).

FIG. 1A is a simplified flow diagram showing a process 150 according to an embodiment. In a first optional step 152, a custom KPI is defined by a user via the interface. In a second step 154, an interface engine is caused to automatically receive a KPI from a database. In a third step 156, the interface engine is caused to display the KPI on a ticker.

### Example

FIG. 2A shows a simplified view of a Home screen display of a user interface, for an Enterprise Resource Planning (ERP) system referencing customer data stored in an underlying HANA™ database of SAP AG of Walldorf, Germany. In particular, the HANA™ exhibits an in-memory architecture allowing rapid access to large quantities of information.

The Home screen 200 of the interface includes a first region 202 configured to display feed information from the ERP program relating to a particular company (CompanyA). The Home screen further includes a second region 204 that is configured to display News information relevant to that company.

As shown in FIG. 2A, the Home screen further comprises a third region 206 corresponding to a ticker according to an embodiment. In particular, region 206 includes a plurality of items 208-211, each corresponding to a particular KPI.

For example, the item 208 of ticker 206 shows the Key Performance Indicator of the Number of Top Cross-Selling Recommendations as obtained by calculating the Expected Revenue, Expected Margin, and Probability of Success in excess of a pre-defined threshold for cross-selling specific products to existing customers. This item 208 comprises an icon 208a, a numeral 208b having a color 208c, and text 208d, all of which serve to provide the user with information relevant to the KPI.

For example, the green color of the numeral indicates it as a non-negative indicator. This coloration is in contrast to that of the item 211, whose red color 211c reveals it to be a negative indicator (e.g. unsatisfied customers).

The interface according to this embodiment is structured to easily and seamlessly provide additional information to the user regarding a particular KPI displayed on the Home page. In particular, the item serves as a link such that clicking thereon provides a drill-down from the highlighted KPI into the detailed advice.

Accordingly, FIG. 2B shows a simplified view of a KPI detail screen reached through the home screen of FIG. 2A. In particular, screen 250 is entitled “19 Top Cross-Selling Recommendations to grow your revenue.” This screen includes recommendations 252 for nineteen (19) additional products 254 to be sold by CompanyA to other potential customers 256 (e.g. CompanyB, CompanyC, . . . etc.)

The screen 250 further displays metrics that may be helpful to a user in evaluating such cross-selling opportunities. For example, the screen includes the metric of probability of success 256 shown in the column “Buying Probability”) and expected revenue 258.

Returning to FIG. 2A, it is noted that the ticker area represents a dynamic display. Thus, as information in the underlying database changes (e.g. new news articles are published, more recent feeds are collected), the ticker area may update with more relevant KPI information.

FIGS. 2C1-2C5 are screen shots of an interface showing how a user may create customized definitions of KPIs. In particular, FIG. 2C1 shows the definition of the Report Groups “Account Intelligence” and “Customer Value Intelligence”.

FIG. 2C2 shows definition of individual reports for the Report Group “Account Intelligence”. FIG. 2C3 shows assignment of Icons and color codings for the KPI Ticker, and assignment of Application Alias for navigation to a detailed report UI.

FIG. 2C4 shows definition of individual reports for the Report Group “Customer Value Intelligence”. FIG. 2C5 shows assignment of Icons and color codings for the KPI Ticker, and assignment of Application Alias for navigation to a detailed report UI.

User interfaces according to various embodiments may offer certain benefits. In the particular example just described, embodiments of interfaces may offer performance gains available from using HANA™ column stores, as contrasted with the conventional row store approaches of traditional ERP systems. This makes it possible to combine transactional and analytical data within the same business context.

Also in connection with the specific example above, the embodiment of the interface allows core foundation multidimensional analytical views of database information to be made available from the HANA™ database, Next Generation ABAP (NGAP), and ByDesign™ to be called on user demand. In addition, data can be updated by report. By being on top of a combination of a database with analytical features, NGAP and Core Foundation make it possible to analyze transactional ERP data in a business warehouse manner directly in one single system.

In general, interface embodiments may afford enhanced visibility of KPI information, offering the user a shortened loop from insight (e.g. recognition of a problem revealed by a KPI value) to action (e.g. correction of that problem).

Moreover, embodiments may result in concrete, actionable advice being pushed to the user quickly. In particular, embodiments may provide recommendations for action that guide the user in correcting a problem or issue revealed by a KPI value. Embodiments thus allow data to be analyzed in a predictive as well as a descriptive manner.

By promoting the visibility of KPIs and providing possible responses thereto, embodiments allow a user to focus on tasks that create value, rather than having to spend time closely monitoring an interface for KPIs and changes thereto.

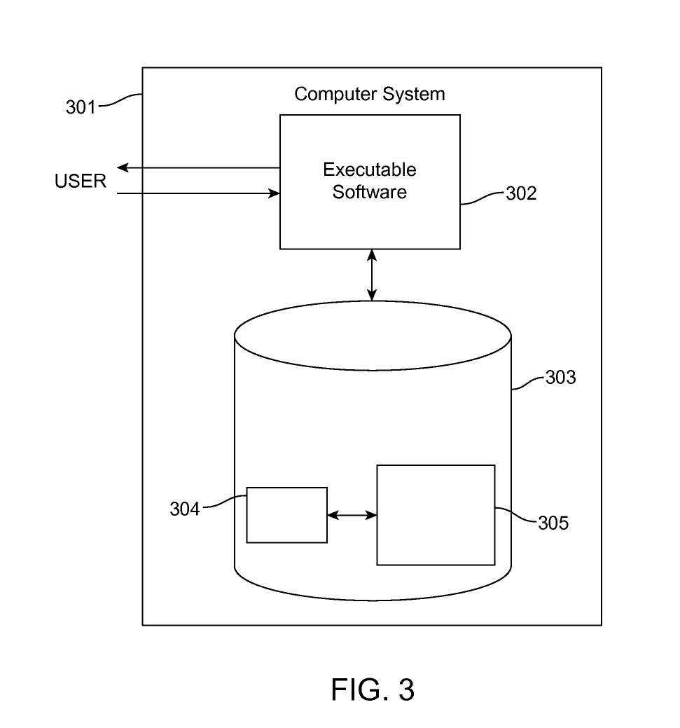

FIG. 3 illustrates hardware of a special purpose computing machine configured to provide a user interface according to an embodiment. In particular, computer system 300 comprises a processor 302 that is in electronic communication with a non-transitory computer-readable storage medium 303. This computer-readable storage medium has stored thereon code 305 corresponding to an interface engine. Code 304 corresponds to a database engine. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

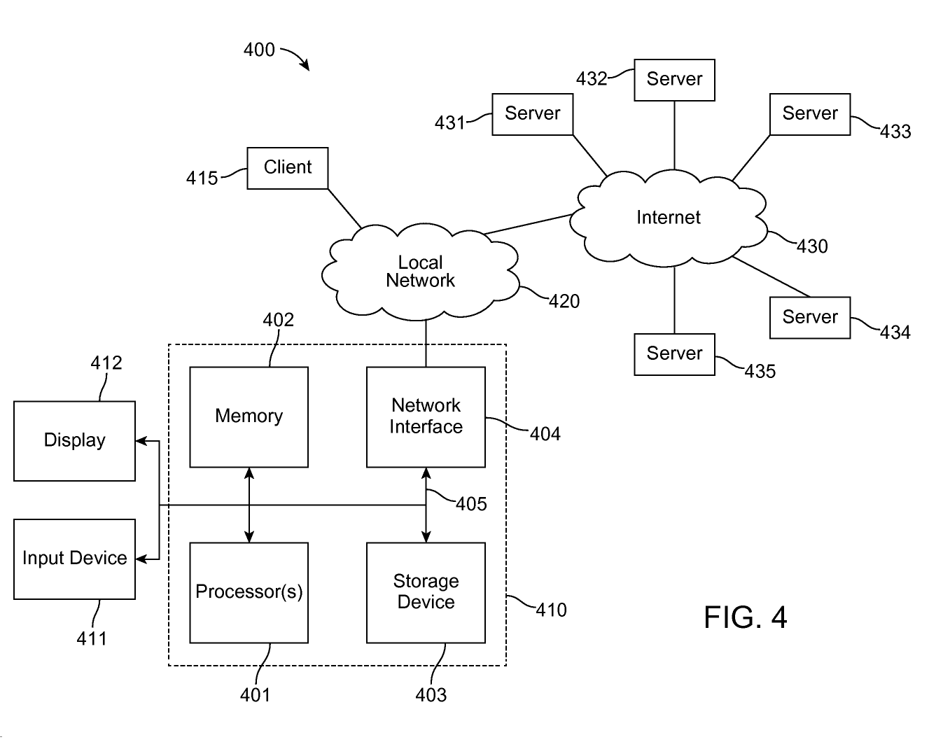

An example computer system 410 is illustrated in FIG. 4. Computer system 410 includes a bus 405 or other communication mechanism for communicating information, and a processor 401 coupled with bus 405 for processing information. Computer system 410 also includes a memory 402 coupled to bus 405 for storing information and instructions to be executed by processor 401, including information and instructions for performing the techniques described above, for example. This memory may also be used for storing variables or other intermediate information during execution of instructions to be executed by processor 401. Possible implementations of this memory may be, but are not limited to, random access memory (RAM), read only memory (ROM), or both. A storage device 403 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 403 may include source code, binary code, or software files for performing the techniques above, for example. Storage device and memory are both examples of computer readable mediums.

Computer system 410 may be coupled via bus 405 to a display 412, such as a cathode ray tube (CRT) or liquid crystal display (LCD), for displaying information to a computer user. An input device 411 such as a keyboard and/or mouse is coupled to bus 405 for communicating information and command selections from the user to processor 401. The combination of these components allows the user to communicate with the system. In some systems, bus 405 may be divided into multiple specialized buses.

Computer system 410 also includes a network interface 404 coupled with bus 405. Network interface 404 may provide two-way data communication between computer system 410 and the local network 420. The network interface 404 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 404 sends and receives electrical, electromagnetic, or optical signals that carry digital data streams representing various types of information.

Computer system 410 can send and receive information, including messages or other interface actions, through the network interface 404 across a local network 420, an Intranet, or the Internet 430. For a local network, computer system 410 may communicate with a plurality of other computer machines, such as server 415. Accordingly, computer system 410 and server computer systems represented by server 415 may form a cloud computing network, which may be programmed with processes described herein. In the Internet example, software components or services may reside on multiple different computer systems 410 or servers 431-435 across the network. The processes described above may be implemented on one or more servers, for example. A server 431 may transmit actions or messages from one component, through Internet 430, local network 420, and network interface 404 to a component on computer system 410. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
causing an interface engine to automatically receive a key performance indicator (KPI) from a database; and
causing the interface engine to display the KPI on a ticker of a screen.

2. A method as in claim 1 further comprising causing the interface engine to display a recommended action based upon the KPI.

3. A method as in claim 1 further comprising:
causing the interface engine to receive an input from a user to define the KPI; and
causing the interface engine to communicate with the database engine to calculate the KPI from the database.

4. A method as in claim 1 wherein the KPI is displayed with a color to indicate a status.

5. A method as in claim 1 wherein the KPI is displayed with movement.

6. A method as in claim 1 wherein the database is configured to store Enterprise Resource Planning (ERP) data.

7. A non-transitory computer readable storage medium embodying a computer program for performing a method, said method comprising:
causing an interface engine to automatically receive a key performance indicator (KPI) from a database; and
causing the interface engine to display the KPI on a ticker of a screen.

8. A non-transitory computer readable storage medium as in claim 7 wherein the method further comprises causing the interface engine to display a recommended action based upon the KPI.

9. A non-transitory computer readable storage medium as in claim 7 further comprising:
causing the interface engine to receive an input from a user to define the KPI; and
causing the interface engine to communicate with the database engine to calculate the KPI from the database.

10. A non-transitory computer readable storage medium as in claim 7 wherein the KPI is displayed with a color to indicate a status.

11. A non-transitory computer readable storage medium as in claim 7 wherein the KPI is displayed with movement.

12. A non-transitory computer readable storage medium as in claim 1 wherein the database is configured to store Enterprise Resource Planning (ERP) data.

13. A computer system comprising:
one or more processors;
a software program, executable on said computer system, the software program configured to:
cause an interface engine to automatically receive a key performance indicator (KPI) from a database; and
cause the interface engine to display the KPI on a ticker of a screen.

14. A computer system as in claim 13 wherein the software program is further configured to cause the interface engine to display a recommended action based upon the KPI.

15. A computer system as in claim 13 wherein the software program is further configured to:
cause the interface engine to receive an input from a user to define the KPI; and
cause the interface engine to communicate with the database engine to calculate the KPI from the database.

16. A computer system as in claim 13 wherein the KPI is displayed with a color to indicate a status.

17. A computer system as in claim 13 wherein the KPI is displayed with movement.

18. A computer system as in claim 13 wherein the database is configured to store Enterprise Resource Planning (ERP) data.
